(19) United States
(12) Patent Application Publication
(10) Pub. No.: US 2007/0218260 A1
(43) Pub. Date: Sep. 20, 2007

(54) Laminate product and method of making same

(76) Inventors: Thierry Miclo, Schiltigheim (FR); Claude Campo, Strasbourg (FR); Jean-Jacques Strub, Strasbourg (FR); Ulrich Zierold, Munchen (DE); Mark Zierold, Blaubeuren (DE); Elmar Beck, Heroldstatt (DE)

Correspondence Address: BRINKS HOFER GILSON & LIONE, P.O. BOX 10395, CHICAGO, IL, 60610, US

(21) Appl. No.: 11/374,290

(22) Filed: Aug. 8, 2005

(30) Foreign Application Priority Data
Nov. 23, 2004 (DE) DE102004056540.6
Aug. 9, 2004 (FR) FR 0451819

(51) Int. Cl. B44C 5/04; B32B 29/02; B32B 3/26; B05D 3/00

(52) U.S. Cl. 428/211.1; 442/412; 428/304.4; 427/326

(57) ABSTRACT

Laminated floorboards with sound damping in a less complicated manner. For this purpose, a compensating element, is provided in which an impregnated paper is joined to an insulating underlay. By means of the use of the compensating element in a laminated floorboard, in which the insulating underlay is used as a sound-damping material layer, in particular using an adhesive coating between paper and underlay, a halving of the sound pressure as compared with a standardized reference floor construction can be demonstrated in a footfall test. A series of process engineering, environmentally friendly and logistical advantages are associated with the use of the process and apparatuses according to the invention for production of compensating element and laminated floorboard, such as the omission of specific fabrication steps, a reduced use of formaldehyde and the ability to use simplified transport apparatuses.

The present invention lies in the area of coated coverings, in particular for floors. It relates to a compensating element, especially an impregnated backing board for laminated floorboards, which is formed from an impregnated paper. Furthermore, the present invention relates to a laminated floorboard having such a compensating element and to a process and an apparatus for production of such compensating elements, especially of impregnated backings and laminated floorboards.

It is known to produce boards for the production of laminated floors by means of coating both sides of wooden boards. Thus there are numerous coated floor coverings which comprise a large number of layers or boards which are connected to one another by means of adhesive bonding or mechanical joining. In many cases, the boards contain a core of wood or a material based on wood, for example of the type HDF (high density fiberboard) or MDF (medium density fiberboard); this means that they consist of wood fibers which are pressed and to which a binder, such as a synthetic resin, is added. This core is covered on its upper side with a decorative layer, such as an impregnated decorative paper, so that a floor laminated board can comprise a decorative layer of printed paper which is applied to the core by means of integration with a polymerizable aminoplastic resin, such as melamine resin. As is known, an overlay, for example in the form of a cellulose paper, is generally applied over the decorative layer in the same way with the aid of an impregnant.

On the underside, a known laminated floorboard can comprise a layer which, in particular, is intended to compensate for internal mechanical stresses in the layer composite. This layer can be a compensating film, but usually consists of a simple kraft or recycled paper layer, which is impregnated or applied by impregnation and is therefore designated an impregnated backing. In the following text, this layer is covered by the term compensating element.

These various layers, the overlay, the decorative layer, the core and the compensating element, are hot-pressed in order to join them to one another and in this way to produce the aforementioned laminated floorboard.

For the purpose of insertion into the pressing device, an auxiliary apparatus is necessary, such as a storage station, on of which the various layers can previously be placed above one another in order that they can be put into the pressing device in the correct structure. This constitutes a problem inasmuch as the material of the lower films of the board, in particular of an impregnated backing or another compensating film, is not very rigid. For example, because of their weight alone, the edges of the compensating elements bend when they are raised by an aid and it is then no longer possible to grip all of the layers placed above one another with clamps or the like.

In order to reduce the noise of movement in such coated laminated floorboards, it is also known to lay sound-damping mats, for example paperboard, cork, felt or a plastic foam film, between the floorboard and the laminated floorboards. In this case, it is also likewise known to fix these sound-damping materials to the laminated floorboard panels before laying the latter, for example by means of adhesive bonding, that is to say the sound-damping material is laminated to the underside of the laminated floorboards in a separate operation. For example, the German utility model specification DE 202 07 218 U1 describes a hard floorcovering, in particular a laminated floorcovering, with integrated sound insulation, which has a supporting board and an impregnated coating fixed to the underside of the supporting board, at least one sound-insulating layer being adhesively bonded to the coating with the impregnating resin as adhesive.

Within the context of the known discontinuous production processes, the production of the abovedescribed laminated floorboard generally comprises at least two basic process steps. During the first process step, the coated board is produced by placing the various layers above one another and subsequent pressing. The second step, after the board has been turned over, comprises the laying and subsequent bonding of the insulating underlay and further pressing, during which the sound-damping materials are fixed as a layer to the lower surface of the aforementioned board. The layer of sound-damping materials can in general terms also be designated as an insulating underlay since, in addition to the function of thermal insulation, it can also perform other insulating tasks if required, such as insulation against heat or humidity. Therefore, the expressions “sound-damping material layer” and “insulating underlay” will be used synonymously hereinafter.

WO 02/100638 A1 describes a laminated floor having two-layer footfall damping. In this case, provision is made to cover the underside of a panel for a floorcovering with a layer consisting of thermoplastic material, which is used for damping sound and which is located on the underside of the panel and, after the laying of the panel, is intended to serve as a contact surface with a subfloor, such as a screed or the like. This further layer or ply, provided in order to damp footfalls, can consist of a very thin, strong paper which has been impregnated with acrylate. The layer which is additionally present is not capable of acting like an impregnated backing which compensates for tensile or compressive stresses in the region of the panel lying above the damping layer, because its positioning at the lowest part of the floor, that is to say under the insulating layer which is relatively soft and/or elastic because of its nature and function.

Both the floor covering according to DE 202 07 218 U1 and the laminated floor of WO 02/100638 A1 entail the disadvantage that an additional operation is needed after the production of the laminated floorboard, in order to apply the damping material executed in one or two layers.

The present invention is placed on the object of configuring the production of laminated floorboards, in conjunction with sound damping on the rear, in a less complicated manner, the intention being to dispense with the necessity for subsequent coating with sound damping material on the finished laminated floor panels.

According to the invention, this is achieved in that a compensating element is provided in which the impregnated layer is joined to an insulating underlay. According to the invention, an impregnated backing is preferably provided in which a sound-damping material layer is applied to one side of the impregnated backing paper by means of an adhesive layer.

Known laminated floorboards are produced in short-cycle or double-belt presses by using highly abrasion resistant overlay paper and printed impregnated decorative paper and a supporting board and an impregnated backing as compensating element, using special press platens or belts under a pressing pressure of, for example, 20 to 40 bar and at pressing temperatures of in particular 160 to 200° C. and pressing times of in particular 8 to 30 s. According to the invention, such a laminated floorboard can now be provided directly with a layer of insulating material without an additional operation, since the impregnated backing according to the invention already has such an insulating material layer. This means that the composite product according to the invention, separate and to be handled individually, comprising impregnated backing paper and sound-damping material layer, is introduced directly into the production process of the laminated floorboard. The laminated floorboard according to the invention produced in such a way surprisingly exhibits improved footfall damping as compared with laminated floorboards of the generic type provided subsequently with a sound-damping material layer, as a result of the whole-area bonding of the materials to one another.

Further features of the invention, in particular the type off process and the construction of the apparatus for production the compensating element or impregnated backing according to the invention are contained in further claims based on claim 1 and also the following description.

The invention will now be explained in more detail by using the exemplary embodiments illustrated in the appended drawings, in which:

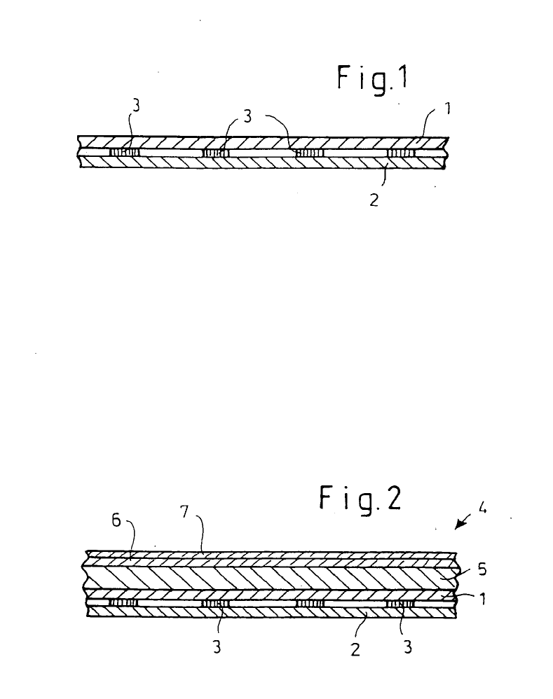

FIG. 1 shows a section through the impregnated backing according to the invention,

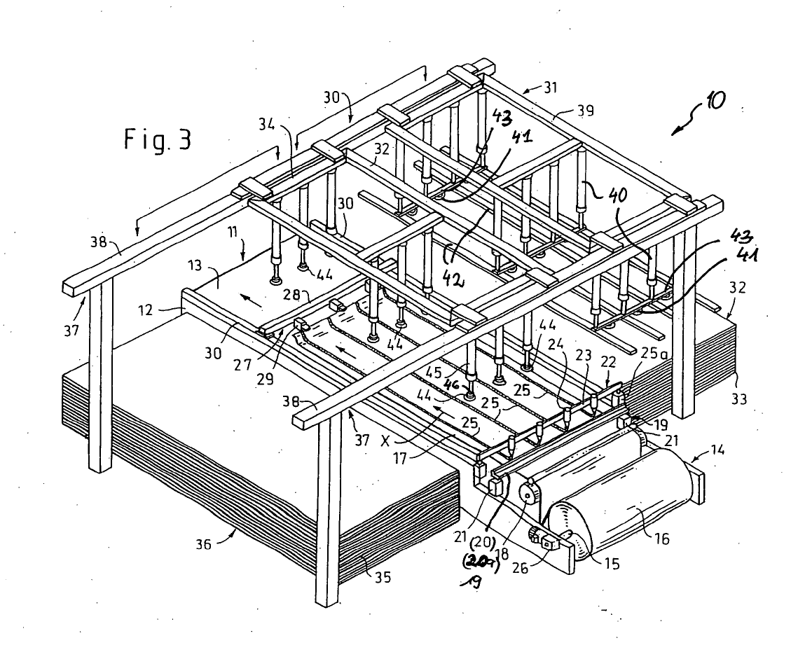

FIG. 2 shows a section through a laminated floorboard according to the invention having an impregnated backing according to FIG. 1,

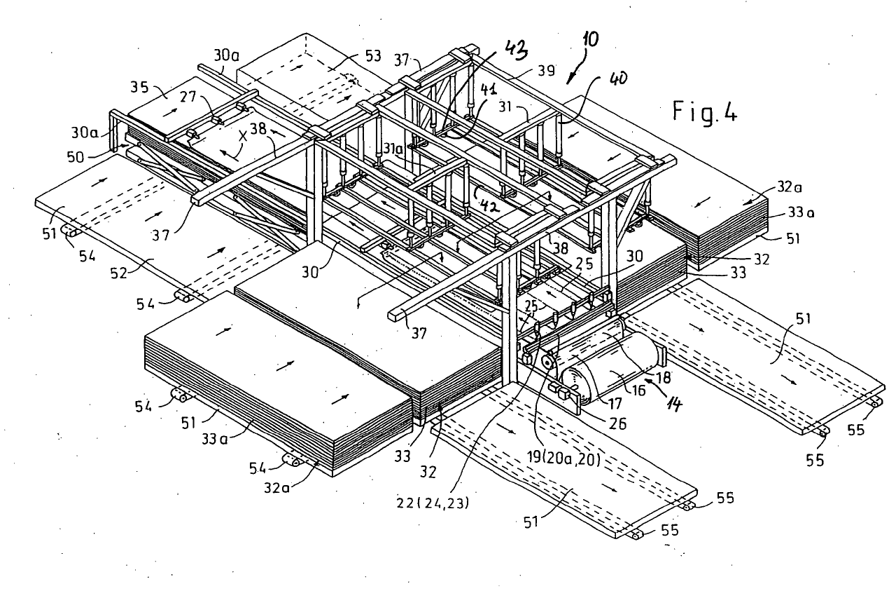

FIG. 3 shows a view of an apparatus according to the invention for producing an impregnated backing according to FIG. 1,

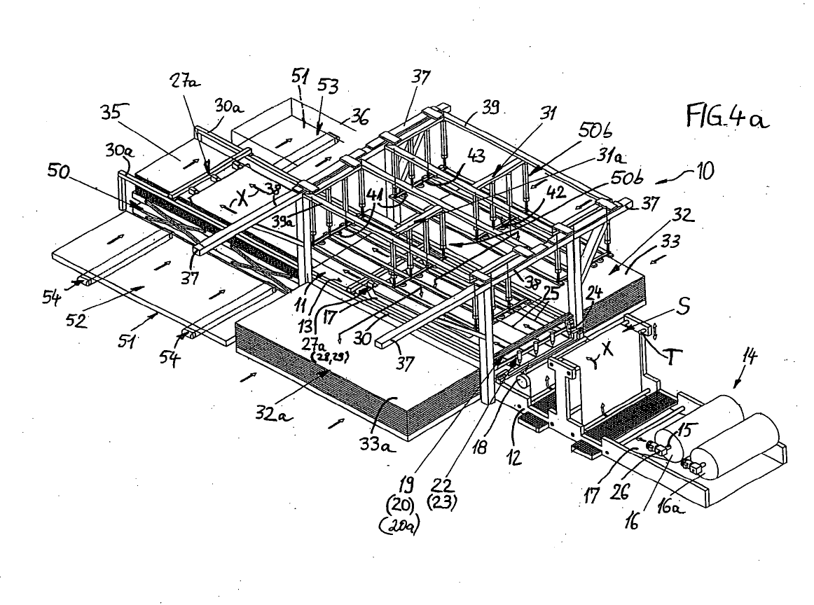

FIG. 4 shows a view of a further apparatus according to the invention for producing an impregnated backing according to FIG. 1,

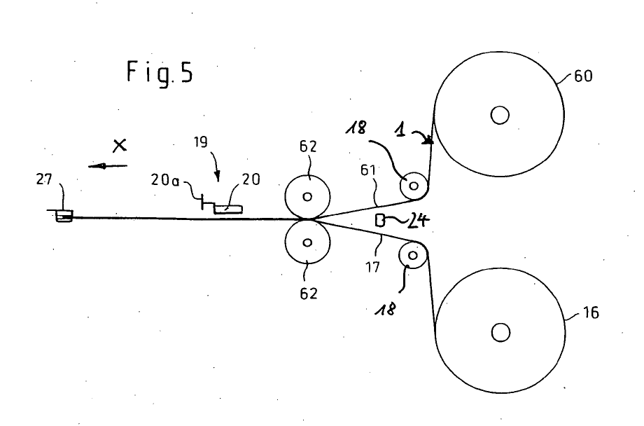

FIG. 5 shows a view of a further apparatus according to the invention for producing an impregnated backing according to FIG. 1,

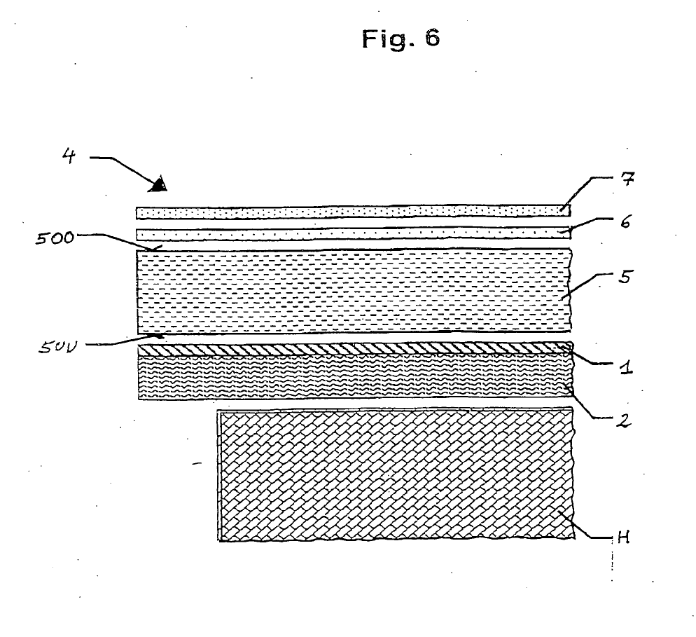

FIG. 6 shows a section through a further embodiment of a laminated floorboard according to the invention, shown in an exploded illustration in order to illustrate its production process.

As FIG. 1 reveals, an impregnated backing formed as a compensating element according to the invention consists of what is known as a backing paper 1, to one side of which a sound-damping material layer 2 is applied by means of an adhesive coating 3. The backing paper 1 advantageously consists of recycled paper based on superior chemical pulps, a base paper grammage of 50 to 140 g/m² being expedient. The final weight following impregnation with resin, for example melamine resin, is preferably 150 to 320 g/m². The quantity of resin used and thus the resultant final weight, as well as the base papers used, depend to a great extent on the construction on the upper side of a laminated floorboard for which the backing paper 1 is used. The resin is preferably an aminoplastic resin, comprising urea and/or melamine resins.

The sound-damping material layer 2 preferably consists of a foamed plastic material. However, the use of felt, cork or a rubber material or mixtures thereof is also possible. Use is preferably made of a polyurethane foam which, in particular, consists of a mixture of recycled polyurethane foam, composite polyurethane foam and binder. The density is preferably 200 to 400 kg/m³, in particular 300 kg/m³. The ignition temperature is preferably more than 400° C. and the decomposition temperature is more than 180° C. The polyurethane foam used according to the invention consists of a film, preferably a polyurethane foam film 1 to 3 mm thick.

The adhesive used for the production of the adhesive coating 3 is preferably a hot-melt adhesive, a contacted adhesive or an emulsified adhesive based on a copolymer. The latter preferably has a viscosity (Brookfield RV 23° C.) of about 7000 mPas with a solids content of about 69% which is preferably present and a pH of about 5.5. The adhesive used according to the invention firstly ensures a good connection between the impregnated backing paper 1 and the sound-damping material layer 2 and withstands the pressing conditions during the production of a laminated floorboard according to the invention.

FIG. 2 demonstrates a laminated floorboard 4 according to the invention, in particular a flooring laminate, produced by using the impregnated backing according to the invention according to FIG. 1. This laminated floorboard 4 comprises a supporting board 5, on whose upper side there is arranged a coating, expediently of an impregnated decorative paper 6, which has a coating of an overlay 7, in particular an overlay paper 7, on its upper side. Both decorative paper 6 and overlay paper 7 are resin-impregnated materials. On its underside, the supporting board 5 has an impregnated backing according to the invention, as described in FIG. 1. In this case, the sound-damping material layer 2 forms the lowest layer of the laminated floorboard 4 according to the invention, this material layer 2 having a composition influenced by the pressing necessitated by production.

The production of the laminated floorboard 4 according to the invention is carried out in particular in a short-cycle or double-belt press, in which the overlay paper 7 is pressed with the printed and impregnated decorative paper 6 and the supporting board 5 and the impregnated backing according to the invention, using specific press platens or belts, under a pressing pressure of 20 to 40 bar at a pressing temperature of 160 to 200° C. with a pressing time of 8 to 30 s. In this case, the pressing is carried out in such a way that the impregnated backing according to the invention with its sound-damping material layer 2 is arranged in such a way that the latter rests against the respective press platen, so that the sound-damping material layer 2 serves as a pressing cushion at the same time. Accordingly, the impregnated backing according to the invention with the impregnated backing paper 1 on the upper side is inserted into the press system in such a way that the supporting board 5 can be placed thereon. Before pressing, the impregnated decorative paper 6 is placed on the supporting board 5 and the overlay paper 7 on the former. The pressing procedure is set in such a way that the finished laminated floorboard 4 ensures adequate flatness during subsequent laying.

The laminated floorboard according to the invention is distinguished by improved damping of movement noise as compared with known boards. This improved damping of movement noise results from the following measurements:

The architectural acoustic properties were determined on two variants of a laminated floor construction and the results were assessed comparatively against what is known as the ihd reference floor structure—DPL laminated floor (thickness: 7.2 mm), PUR foam film (density: 22 kg/m³, thickness 3.0 mm), PE film (usual vapor barrier, thickness 0.2 mm). The footfall behavior during movement was determined in accordance with ihd Standard 431:

The tests were carried out on the following laminated floor constructions:
Variant 1: “Standard” DPL laminate (panel dimensions: 194×1290×7 mm), PE foam film (thickness: 3 mm), underlaid, PE film and moisture barrier;
variant 2: DPL laminate according to the invention (panel dimensions 194×1290×7.5 mm) with integrated PUR foam mat (thickness: 3 mm), PE film as moisture barrier.

The testing was carried out in a measurement room in which a concrete discrete area of 2.40 m length, 2 m width and about 12 cm thickness is installed at the center. In each case in 15 measurements of the sound of movement which arose when a tester wearing heeled shoes (hard rubber covering) walked uniformly over the laid floor constructions were carried out. In order to characterize the architectural acoustic properties, the sound of movement from the first step of the tester on the path walked was used. The measured variables used for the sound of movement produced were the A-weighted total sound pressure level of the registered frequency range (25 Hz to 12,500 Hz) in dB(A) and also the psychoacoustic loudness in sons, which were determined in accordance with the method described in ihd Standard 471 Version 04/2003.

The characteristic values determined for the floor constructions are compared in tables 1 and 2. The characteristic values were determined after removing the largest and smallest measured value (outlier correction) in accordance with ihd Standard 471 Version 04/2003.

The result is revealed as the respective difference of the total sound pressure level or the loudness of the variants examined with respect to the reference structure.

The level of improvement of the total sound pressure level should be assessed as follows:
+0.5 dB(A)—improvement perceptible only under good acoustic conditions
+1.0 dB(A)—perceptible threshold for improvements
+3.0 dB(A)—halving of the signal energy
+6.0 dB(A)—halving of the sound pressure
+10 dB(A)—halving of the subjective loudness

The change in the linear characteristic variable loudness (N) in percentage terms in relation to the reference is determined as follows.

Percentage change:

$$\frac{( {N}_{ref} - {N}_{j} )}{{N}_{ref}} * 100 \%$$

The characteristic value determined indicates the percentage increase (negative value)/reduction (positive value) in the loudness sensation.

TABLE 1
A-weighted total sound pressure level

| | | | Level of |
|---|---|---|---|
| | Reference | Sample | improvement |
| | (mean spectrum) | (mean spectrum) | ΔL = L_{tot. ref} − Lₜₒₜ |
| Var. | (\|N_{tot. ref}\| = dB(A)) | (\|N_{tot. j}\| = dB(A)) | (\|ΔL\| = dB(A)) |
| 1 | 73.1 | 71.9 | 1.2 |
| 2 | 73.1 | 67.6 | 5.5 |

TABLE 2
Loudness

| | | Loudness of | | |
|---|---|---|---|---|
| | Reference | the sample | Difference in the | |
| | (mean spectrum) | (mean spectrum) | loudness in sons | |
| Var. | (\|N_{ref}\| = sons) | (\|Nⱼ\| = sons) | rel. difference in % | |
| 1 | 22.2 | 21.9 | 0.3 | 1.4 |
| 2 | 22.2 | 17.7 | 4.5 | 20.1 |

The “Standard” variant 1 emitted sound of movement approximately of the same intensity as the ihd reference floor construction.

Variant 2, by contrast, was distinguished by a reduction in the emitted sound energy. The audibly lower sound emission when variant 2 was walked on as compared with variant 1 manifests itself in the form of a lower A-weighted total sound pressure level and a lower loudness value (see table 1 and table 2).

The result is an improvement in the sound of movement over the standard of about +6 dB(A), that is to say a halving of the sound pressure and a reduction in the loudness value of more than 20% in accordance with ihd Standard Version 04/2003.

Furthermore, the laminated floorboard 4 according to the invention is distinguished by economic and ecological advantages since, for example, there is a smaller proportion of formaldehyde present. Furthermore, supply in customer format with a processing guarantee is possible. The laminated floorboards 4 according to the invention can be cut into planks of the desired dimensions following the pressing and maturing process. These planks, already provided with the insulating layer, can be milled with a tongue and groove joint and packed ready for sale. HDF, MDF, chipboard or recycled boards or the like can be used as the material of the supporting board 5.

By using FIG. 3, an apparatus 10 according to the invention for producing an impregnated backing according to the invention will be described. As can be seen from FIG. 3, this laminating apparatus 10 according to the invention comprises a supporting apparatus 11 which comprises a framework 12 to be fixed to a floor slab, and a flat supporting surface 13. An unwinding device 14 is arranged at one end of the supporting surface 13. This unwinding device 14 has a bearing holder with a bearing shaft 15 on which a roll 16 of insulating material is arranged and from which a web 17 of insulating material rolled up on the roll 16 of insulating material can be pulled off in the haul-off direction X in order to form the sound-damping material layer 2 of the impregnated backing. The unwinding device 14 also has a deflection roller 18 for the web 17 of insulating material, mounted in the framework 12 immediately after the roll 16 of insulating material in the haul-off direction X.

A crosscutter 19 is fixed to the framework 12 after the deflection roller 18 in the haul-off direction X. Said crosscutter comprises, for example, a clamping bar 20 running transversely, in particular at right angles, to the haul-off direction X above the web 17 of insulating material and the supporting surface 13 and on which a circular knife 20a is guided such that it can be moved. The clamping bar 20 can be lowered and raised again by means of actuators fastened thereto at both ends in order to cut off or cut to length the web 17 of insulating material.

Arranged after the crosscutter 19 in the haul-off direction X is an adhesive applicator 22. This applicator 22 comprises a carrier 23 running transversely, in particular at right angles, to the haul-off direction X and on which applicator nozzles 24 aimed in the direction of the supporting surface 13 are fixed. At its ends, the carrier 23 is fixed to actuators 25a, with which the carrier 23 with the applicator nozzles 24 for applying an adhesive to the web 17 of insulating material can be lowered in the direction of the supporting surface 13 and raised again. In the exemplary embodiment illustrated there are four equally spaced applicator nozzles 24 for the adhesive coating 3, with which four adhesive tracks 25 can be applied to the web 17 of insulating material. However, it is likewise within the scope of the invention to provide more or fewer applicator nozzles 24. The coating weight is in this case preferably on average 10 g/m².

Furthermore, the supporting apparatus 11 has a gripping apparatus 27, with which the web 17 of insulating material to be pulled off the roll 16 of insulating material can be gripped and pulled in the direction of the haul-off direction X over the supporting surface 13 until the desired cut length dimension for the web 17 of insulating material is reached. The gripping apparatus 27 comprises a beam 28 running transversely, in particular at right angles, to the haul-off direction X and on which grippers 29, in the example shown three grippers 29 spaced apart equally from one another, are fixed. These grippers 29 can be actuated electrically or pneumatically and are constructed in such a way that the free end of the web 17 of insulating material can be gripped securely and fixed and released again after being cut to length. At its end, the beam 28 is mounted on guide strips 30 on a drive device, in particular a linear drive device. This linear drive device is constructed in a known manner and therefore not specifically described. In order to pull the web 17 of insulating material easily off the roll 16 of insulating material, an electric motor 26 driving the bearing shaft 15 is provided, which means that the action of pulling off the web 17 of insulating material by means of the gripping device 27 can also be assisted, for which reason the speed of the haul-off movement of the grippers 29 in the haul-off direction X by means of the linear drive and the drive speed of the electric motor 26 can advantageously be coordinated with each other in control terms.

The supporting apparatus 11 further comprises a lifting, depositing and transport apparatus 31 with which in-impregnated paper blanks 33 stacked on one side beside the supporting surface 13 to form a paper stack 32, which correspond to the backing paper (impregnated paper 1) according to FIG. 1, can be lifted, transported transversely, in particular at right angles, to the haul-off direction X and can then be lowered again from a position above the supporting surface 13.

Using a further transport apparatus 34, blanks 35 of impregnated backings according to the invention fabricated on the supporting surface 13, as described in FIG. 1, can be lifted off the supporting surface 13, transported transversely, in particular at right angles, to the haul-off direction X and deposited to form a stack 36, which is arranged opposite the paper stack 32 and parallel to the supporting surface 13, beside the latter.

The two transport apparatuses 31, 34 are guided such that they can be displaced in two portal carriers 37 arranged transversely, in particular and right angles, to the haul-off direction X and parallel to each other, on their horizontal carrier sections 38 and can be moved independently of each other by a conventional linear drive or the like.

The transport apparatus 31 in this case comprises a transport frame 39, on which suckers 41 and pressure strips 42 that can be lowered and pulled up via pneumatic or hydraulic piston-cylinder units 40 are fixed. The suckers 41 and pressure strips 42 lie with their supporting surfaces for the paper blanks 33 in the same plane, which runs parallel to the stacked paper blanks 33.

In the exemplary embodiment illustrated, there are three rows of four piston-cylinder units 40 in each case and three suckers 41 in each case arranged in parallel. Here, these suckers 41 of each row are fixed on a carrier strip 43 in particular running at right angles to the haul-off direction X. In addition, four pressure strips 42 running parallel to one another and at right angles to the carrier strips 43 are provided. In each case one of the pressure strips 42 is arranged at the free ends of the carrier strips 43 and the two other pressure strips 42 are arranged in such a way that the distance to the adjacent pressure strips 42 of a unit 40 and their mutual spacing is equal.

The transport device 34 for the impregnated backing blanks 35 according to the invention has substantially the same construction in relation to the arrangement and formation of the transport frame and the fixing of suckers 44 to piston-cylinder arrangements 45. To this extent, identical parts are provided with the same reference numbers. However, in this case the suckers 44 are fixed directly transversely, in each case to the free end of the piston rod 46 of a piston-cylinder arrangement 45. In addition, the pressure strips are not required. In the suckers 41, 44, the sucking action is achieved by generating vacuum. In a preferred embodiment, the paper blanks 33 and the impregnated backing blanks 35 have a length of 2400 to 5700 mm and a width of 1260 to 2080 mm.

The operation of the laminating apparatus 10 according to the invention is as follows. As soon as the paper stack 32 of paper blanks 33 and the roll 16 of insulating material have been provided, the gripping apparatus 27 is moved directly up to the crosscutter 19 in order to grip and to fix the free end of the web 17 of insulating material pulled off the roll 16 of insulating material by the required length as far as the crosscutter 19. The width of the paper blanks 33 is matched to the width of the web 17 of insulating material.

As soon as the web 17 of insulating material has been gripped by the grippers 29, the web 17 of insulating material is moved in the haul-off direction X by moving the gripping apparatus 27 by means of the linear drive and, in this way, the web 17 of insulating material is pulled over the supporting surface 13 until the desired length of the web 17 lying on the supporting surface 13 has been reached. During the haul-off operation, the adhesive tracks 25 are applied to the web 17 of insulating material by the applicator nozzles 24. When the haul-off operation is completed, the application of adhesive is also ended.

After that, the clamping bar 20 of the crosscutter 19 is lowered and the web 17 of insulating material is fixed and cut to length with the circular knife 20a.

By means of the transport device 31, a paper blank 33 is now lifted off the paper stack 32. For this purpose, the transport device 31 is positioned over the paper stack 32 and the suckers 41 are lowered by the pressure strips 42 until they rest on the topmost paper blank 33. A vacuum is then generated in the suckers 41 and thus the paper blank 33 is fixed in contact with the pressure strips 42. In this state, the suckers 41 one and the pressure strips 42 are lifted and the transport apparatus 31 is moved until it is positioned exactly above the web 17 of insulating material.

From this position, the paper blank 33 is lowered onto the web 17 of insulating material and laid on it, with the paper blank 33 being pressed onto the web 17 of insulating material by means of the pressure strips 42. Since the pressure strips 42 are arranged in such a manner that they run above the adhesive tracks 25, the maximum pressure is applied where the application of adhesive is present. This results in good and reliable adhesive bonding between the web 17 of insulating material and the paper blank 33.

Then, the vacuum in the suckers 41 is removed so that they can be lifted together with the pressure stips 42 and the transport device 31 can be moved back over the paper stack 32.

After that, the transport device 34 which, until this time, had been positioned over the impregnated backing stack 36, is moved over the coated web 17 of insulating material and aligned exactly above the latter. From this position, the suckers 44 are lowered onto the surface of the coated web 17 of insulating material.

In the contact position of the suckers 44, vacuum is generated in the latter and us the coated web 17 of insulating material is fixed to the suckers 44. The grippers 29 are then opened and pulled back and the clamping bar 20 is lifted, so that the cut and coated web 17 of insulating material, which forms the impregnated backing blank 35 according to the invention, can be lifted and moved out of the stack 36. From this position, the impregnated backing blank 35 is lowered and, in the lowered position, the vacuum in the suckers 44 is canceled. After that, the process described above begins again.

The basic structure of the further embodiment, shown in FIG. 4, of an apparatus according to the invention for producing an impregnated backing according to the invention matches the embodiment shown in FIG. 3. To this extent, if not otherwise described in the following text, reference is made to the full extent to the preceding embodiments. The second embodiment of the apparatus according to the invention is distinguished by a higher capacity, which is increased by some measures increasing efficiency, in particular measures of a logistical nature.

Thus, it bercomes clear from the illustration, firstly, that impregnated paper blanks 33 corresponding to the backing paper (impregnated paper 1) according to FIG. 1 in each case stacked to form a paper stack 32 are arranged on both sides beside the supporting surface 13 of the supporting apparatus 11. As a result, a shorter cycle time can be achieved during the paper feed. In order to feed the backing paper 1, in this case two lifting, depositing and transport apparatuses 31, 31a assigned to the two paper stacks 32 are used, by means of which the stacked impregnated paper blanks 33 can be lifted, transported transversely, in particular at right angles, to the haul-off direction X and can subsequently been lowered again from a position above the supporting surface 13. The structure of the two lifting, depositing and transport apparatuses 31, 31a corresponds to that which has been described for the transport apparatus 31 of the paper blanks 33 with reference to FIG. 3. The second transport apparatus 31a in the embodiment illustrated in FIG. 4 occupies the space of the lifting, depositing and transport apparatus 34 for the finished impregnated backing blanks 35, it being possible for the latter to be transported away from the supporting surface 13 longitudinally with respect to the haul-off dimension X rather than transversely in the embodiment illustrated. For this purpose, use is made of the abovedescribed gripping apparatus 27, with which the web 17 of insulating material to be pulled off the roll 16 of insulating material can be gripped and pulled over the supporting surface 13 in the direction of the haul-off direction X. The output conveyance longitudinally with respect to the haul-off direction X becomes possible in this case through the fact that, as a result of the presence of guide rods 30a for the gripping device 27, adjoining the guide strips 30 running at the side of the supporting surface 13, a lengthened conveying path is created. In this case, a lifting table 50 is arranged behind the supporting surface 13 and is used to accommodate the impregnated backing blanks 35 led away from the supporting surface 13, it being possible for said blanks in turn to form a stack 36 in a simple way, in particular on a pallet 51, as a result of the ability of the lifting table 50 to be displaced vertically.

The lifting table 50 is assigned at least one transverse conveyor 54, by means which unstacked pallets 51 can be moved onto the lifting table 50 from the side and stacked pallets 51 can likewise be transported away laterally, in particular on the opposite side of the lifting table 50. In order to implement these transport operations, a standby space 52 for the unstacked pallets 51 and a storage space 53 for the pallets 51 loaded with the impregnated backing stack 36 is illustrated in FIG. 4.

In addition, the impregnated paper blanks 33 each stacked to form paper stacks 32 can be supplied on pallets 51, it being possible for these pallets 51 to be the same as are used for the transport of the impregnated backing blanks 35. In the same way, standby spaces can also be provided for the paper blanks 33 or their stacks 32, in particular, as seen in the direction of the haul-off direction X, laterally beside the stack 32 used for the direct paper feed to the supporting surface 13, which is illustrated by the reference symbols 33a and 32a in FIG. 4 and the associated transverse conveyor 54. The output conveyance of the pallets 51 emptied of the paper blanks 33 can in each case be implemented with the aid of longitudinal conveyors 55 opposed to the haul-off direction X, as can likewise be gathered from FIG. 4.

By using FIG. 4a, a further apparatus 10 according to the invention for producing an impregnated backing according to the invention will be described. As can be seen from FIG. 4a, this laminating apparatus 10 according to the invention comprises a supporting apparatus 11, which comprises a framework 12 to be fixed to a floor slab and a flat supporting surface 13. An unwinding device 14 is arranged at one end of the supporting surface 13. This unwinding device 14 has a bearing holder with a bearing shaft 15 on which a roll 16 of insulating material is arranged and from which a web 17 of insulating material rolled up on the roll 16 of insulating material can be pulled off in the haul-off direction X in order to form the sound-damping material layer 2 of the impregnated backing. The unwinding device 14 can have an additional spare roll 16a. A deflection roller 18 for the web 17 of insulating material is mounted in the framework 12 immediately after the roll 16 of insulating material in the haul-off direction X. A storage device S having vertically movable dancer rollers T for the web 17 of insulating material can be arranged—as illustrated—between the unwinding device 14 and the deflection roller 18.

A crosscutter 19 is fixed to the framework 12 after the deflection roller 18 in the haul-off direction X. Said crosscutter comprises, for example, a clamping bar 20 running transversely, in particular at right angles, to the haul-off direction X above the web 17 of insulating material and the supporting surface and on which a circular knife, not illustrated, is guided such that it can be moved. The clamping bar 20 can be lowered and raised again by means of actuators fastened thereto at both ends in order to hold the web of insulating material firmly while the circular knife cuts off the web 17 of insulating material while being moved and guided.

Arranged before the crosscutter 19 in the haul-off direction X is an adhesive applicator 22. This applicator 22 comprises a carrier 23 running transversely, in particular at right angles, to the haul-off direction X and on which applicator nozzles 24 aimed in the direction of the supporting surface 13 are fixed. The adhesive is sprayed onto the web 17 of insulating material by the applicator nozzles 24.

In the exemplary embodiment illustrated there are four spaced-apart applicator nozzles 24 for the adhesive coating, with which four adhesive tracks 25 can be applied to the web 17 of insulating material. However, it is likewise within the scope of the invention to provide more or fewer applicator nozzles 24. The coating weight is in this case preferably on average 10 g/m².

Furthermore, the supporting apparatus 11 has a gripping apparatus 27a, with which the web 17 of insulating material to be pulled off the roll 16 of insulating material can be gripped and pulled in the direction of the haul-off direction X over the supporting surface 13 until the desired cut length dimension for the web 17 of insulating material is reached. The gripping apparatus 27a comprises a beam 28 running transversely, in particular at right angles, to the haul-off direction X and on which grippers 29, in the example shown three grippers 29 spaced apart equally from one another, are fixed. These grippers 29 can be actuated electrically or pneumatically and are constructed in such a way that the free end of the web 17 of insulating material can be gripped securely and fixed and released again after being cut to length. At its end, the beam 28 is mounted on guide strips 30 on a drive device, in particular a linear drive device. This linear drive device is constructed in a known manner and therefore not specifically described. In order to pull the web 17 of insulating material easily off the roll 16 of insulating material, an electric motor 26 driving the bearing shaft 15 is provided, which means that the action of pulling off the web 17 of insulating material by means of the gripping device 27a can also be assisted, for which reason the speed of the haul-off movement of the grippers 29 in the haul-off direction X by means of the linear drive and the drive speed of the electric motor 26 can advantageously be coordinated with each other in control terms.

The supporting apparatus 11 further comprises a lifting, depositing and transport apparatus 31 with which in-impregnated paper blanks 33 stacked on one side beside the supporting surface 13 to form a paper stack 32, which correspond to the backing paper (impregnated paper 1) according to FIG. 1, can be lifted, transported transversely, in particular at right angles, to the haul-off direction X and can then be lowered again from a position above the supporting surface 13.

Using a further transport apparatus 31a, blanks 35 of impregnated backings according to the invention fabricated on the supporting surface 13, as described in FIG. 1, can be lifted off the supporting surface 13, transported transversely, in particular at right angles, to the haul-off direction X and deposited to form a stack.

The two transport devices 31, 31a are guided displaceably in two portal carriers 37 arranged transversely, in particular at right angels, to the haul-off direction (X) and parallel to each other, on horizontal carrier sections 38 thereof, and can be moved independently of each other by means of a standard linear drive or the like.

The transport device 31, 31a in this case comprises a transport frame 39, 39a, on which suckers 41 which can be lowered and pulled up by pneumatic or hydraulic lifting devices 50a, 50b are fixed underneath. The suckers 41 lie with their supporting surfaces for the paper blanks 33, 33a in the same plane, which runs parallel with the stacked paper blanks 33, 33a.

In the exemplary embodiment illustrated, there are two lifting devices 50a, 50b with about sixty-six suckers 41 each. In this case, the suckers 41 of each row fixed to a supporting frame 43 running in particular at right angles to the haul-off direction X.

The transport device 31, 31a for the impregnated backing blanks 35 according to the invention has substantially the same construction in relation to the arrangement and formation of the transport frame and the fixing of suckers 41 to the portal frame.

In the suckers 41, the sucking action is achieved by generating vacuum. In a preferred embodiment, the paper blanks 33 and the impregnated backing blanks 35 have a length of 2400 to 5700 mm and a width of 2050 to 2090 mm.

The operation of the laminating apparatus 10 according to the invention is as follows. As soon as the paper stack 32 of paper blanks 33 and the roll 16 of insulating material have been provided, the gripping apparatus 27a is moved directly up to the crosscutter 19, in order to grip and to fix the free end of the web 17 of insulating material pulled off the roll 16 of insulating material by the required length as far as the crosscutter 19. The width of the paper blank 33, 33a is matched to the width of the web 17 of insulating material in accordance with the customer's requirement.

As soon as the web 17 of insulating material has been gripped by the grippers 29, the web 17 of insulating material is moved in the haul-off direction X by moving the gripping apparatus 27a of the linear drive and, in this way, the web 17 of insulating material is pulled over the supporting surface 13 until the desired length of the web 17 lying on the supporting surface 13 has been reached. During the haul-off operation, the adhesive tracks 26 are applied to the web 17 of insulating material by the applicator nozzles 24. When the haul-off operation is completed, the application of adhesive is also ended.

After that, the clamping bar 20 of the crosscutter 19 is lowered and the web 17 of insulating material is fixed and cut to length with the circular knife.

By means of the transport device 31, 31a, a paper blank 33, 33a is then lifted alternately off the paper stack 32, 32a. For this purpose, the transport device 31, 31a is positioned above the paper stack 32, 32a and its suckers 41 are lowered until they rest on the topmost paper blank 33, 33a. A vacuum is then generated in the suckers 41 and the paper blank 33, 33a is thus fixed. In this state, the suckers 41 with the paper blank 33, 33a are lifted and the transport apparatus 31, 31a is moved until they are positioned exactly above the web 17 of insulating material.

From this position, the paper blank 33, 33a is lowered toward the web 17 of insulating material and deposited on the latter, the paper blank 33, 33a being pressed by the suckers 41 against the web 17 of insulating material where the application of adhesive is present.

In this way, a good and secure adhesive bond between the web 17 of insulating material and the paper blank 33, 33a is achieved.

The vacuum in the suckers 41 is then canceled, so that the scissors lifting table 50 can be raised and the transport device 31, 31a can be moved out of the paper stack 32, 32a again.

Thus, it becomes clear from the illustration, firstly, that impregnated paper blanks 33, 33a corresponding to the backing paper (impregnated paper 1) according to FIG. 1 in each case stacked to form a paper stack 32, 32a are arranged on both sides beside the supporting surface 13 of the supporting apparatus 11. As a result, a shorter cycle time can be achieved during the paper feed. In order to feed the backing paper 1, in this case two lifting, depositing and transport apparatuses 31, 31a assigned to the two paper stacks 32, 32a are used, by means of which the stacked impregnated paper blanks 33, 33a can be lifted, transported transversely, in particular at right angles, to the haul-off direction X and can subsequently be lowered again from a position above the supporting surface 13. The structure of the two lifting, depositing and transport apparatuses 31, 31a corresponds to that which has been described for the transport apparatus 31 of the paper blanks 33 with reference to FIG. 3. The second transport apparatus 31a in the embodiment illustrated in FIG. 4a occupies the space of the lifting, depositing and transport apparatus 34 for the finished impregnated backing blanks 35, it being possible for the latter to be transported away from the supporting surface 13 longitudinally with respect to the haul-off dimension X rather than transversely in the embodiment illustrated. For this purpose, use is made of the abovedescribed gripping apparatus 27a, with which the web 17 of insulating material to be pulled off the roll 16 of insulating material can be gripped and pulled over the supporting surface 13 in the direction of the haul-off direction X. The output conveyance longitudinally with respect to the haul-off direction X becomes possible in this case through the fact that, as a result of the presence of guide rods 30a for the gripping device 27a, adjoining the guide strips 30 running at the side of the supporting surface 13, a lengthened conveying path is created. In this case, a lifting table 50 is arranged behind the supporting surface 13 and is used to accommodate the impregnated backing blanks 35 conveyed away from the supporting surface 13, it being possible for said blanks in turn to form a stack 36 in a simple way, in particular on a pallet 51, as a result of the ability of the lifting table 50 to be displaced vertically.

The lifting table 50 is assigned a transverse conveyor 54, by means which unstacked pallets 51 can be moved onto the lifting table 50 from the side and stacked pallets 51 can likewise be transported away laterally, in particular on the opposite side of the lifting table 50. In order to implement these transport operations, a standby space 52 for the unstacked pallets 51 and a storage space 53 for the pallets 51 loaded with the impregnated backing stack 36 is illustrated in FIG. 4a.

FIG. 5 shows a basic illustration of a further embodiment according to the invention of an apparatus for production an impregnated backing according to the invention. This permits the production of an impregnated backing according to FIG. 1 by using impregnated backing paper 1 supplied in roll form. Identical parts to those in FIGS. 3 and 4 are identified by the same reference numbers. In this apparatus, a roll 60 of rolled, impregnated backing paper 1 is mounted above the roll 16 of insulating material, as illustrated in FIGS. 3 and 4. A web 61 of backing paper is pulled off in the haul-off direction X. The applicator nozzles 24 for applying the adhesive (adhesive coating 3) are arranged after the deflection roller 18 in the haul-off direction X. Behind the applicator nozzle 24 there is a pair of pressure rollers 62 arranged one about the other, the web 61 of backing paper and the web 17 over insulating material lying one above the other being pulled jointly through their roller nip and pressed against each other, so that bonding takes place. The clamping bar 20 having the crosscutter 19 is arranged after the pressure rollers 62 in the haul-off direction. By means of the gripping apparatus 27, the free ends of the web 61 of backing paper lying one above the other and of the web 17 of insulating material are gripped and these are pulled in the haul-off direction X, specifically until the desired length of the impregnated backing is reached. As soon as this length has been reached, the pulling movement is stopped and the impregnated backing is cut to length and then transported onward in the haul-off direction, for which reference can be made to the embodiment according to FIG. 4. The embodiment according to FIG. 5 needs the least effort in terms of construction and permits the highest fabrication speed.

In the further embodiment, illustrated in FIG. 6, of a laminated floorboard 4 according to the invention, shown in an exploded illustration in order to illustrate its preferred production process, the same reference symbols as in FIG. 2 are used to designate mutually corresponding parts.

The laminated floorboard 4 according to the invention is used for the production of a floor covering built up from layers, and contains a wood-based core, already designated the supporting board 5 above, which can be produced specifically from a wood-derivative board of the HDF or MDF type or else from synthetic or plastic recycled material particles. On the surface 500 of the same there is a decorative covering, in particular an impregnated decorative paper 6, and an overlay 7. On the underside 5UU there is arranged a composite of an impregnated backing paper 1 and an insulating underlay 2 as a compensating element.

The insulating underlay 2 can be, for example, a noise-damping or temperature-damping material layer, in order to insulate the floor covering with respect to the surface to which it is applied against noises, temperature or the like. The insulating underlay 2 can consist of various materials corresponding to the desired insulation, in particular and for example of cork, of pressed wood chips with a low density, of polyurethane or else of a thin sheet of synthetic fibers.

In order to fix the insulating underlay 2 to the laminated floorboard 4, the underlay 2 is joined first to the paper 1 before the other layers, which are then in total intended to form the aforementioned board 4, are placed above one another before being put into a pressing apparatus. This operation makes it possible to stabilize the layers which are intended to be fitted under the surface 5UU of the core of the board 4. This improved stability prevents the edges of the lower layers bending or bulging under their own weight.

For the fixing of the underlay 2 to the paper 1, before the pressing operation for the layers which are intended to form the aforementioned laminated floorboard 4, adhesive means are provided. In this case, as in the embodiment according to FIG. 2, the adhesion can be provided by adhesively bonding the insulating underlay 2 to the paper by means of a binder (adhesive coating 3) such as resin, for example of the melamine type. The binder can be applied directly before the contact between the two surfaces of the underlay 2 and the paper 1 or else a film.

However, the adhesion can also be provided by using an electrostatic effect, specifically by the impregnated paper 1 being connected to the insulating underlay 2 by means of the attractive action when there is different electrostatic charging of the layers to be connected. The electrostatic effect can in this case also be used to improve the adhesion of the paper to the underlay 2 only temporarily during the time period needed for the bonding of the two layers when a different primary adhesive means is used, such as the aforementioned binder.

In a special embodiment, in order to achieve the adhesion, the application of a binder used when producing the insulating underlay 2 can also be considered, for example a resin in the case of an underlay 2 made of cork, of pressed particles or similar materials. The paper 1 can then advantageously already be applied to the underlay 2 during the production of the latter.

The underlay 2 and the paper 1 can be of the size of the board 4 to which they are to be fixed. They can also be unwound continuously with each other from rolls, spools or winding apparatuses—as already explained above in detail—and, following their transport and possible pre-treatment, can be stored again on rolls, spools or winding apparatuses before they are then finally cut to size before the operation of laying them one above another with the other layers which are intended to form the aforementioned board 4.

When the insulating underlay 2 and the paper 1 have been connected to each other to form a compensating element according to the invention, the element—with underlay 2 pointing down—forming the lowest layer of the laminated floorboard 4 according to the invention, the other layers which are intended to form the floorcovering board 4 are placed above one another successively, beginning with the lower surface 5UU of the supporting board 5, for example on an aid H, as illustrated in FIG. 6, specifically in the following order: wood-based core, decorative film 6, overlay 7.

The whole formed in this way can be gripped easily, so that it can be lifted off the aid H and moved into a pressing apparatus in an uncomplicated way, specifically by using means suitable for gripping layers. These means can have the form of clamps or another form which is suitable to grip the various layers in order to lay them on one another. For example, gripping means operating in particular with vacuum, in the manner of suction cups, can be used, as described above as suckers 41, 44. Bending or sagging of the edge regions does not occur, since the compensating element according to the invention forms an adequately stable storage plane for transport for the layers arranged above it.

In order to bond all of the layers which are intended to form the laminated floorboard 4, only a single pressing operation is advantageously needed. The operation of adhesively bonding the paper 1 between two pressing process steps is no longer necessary.

The present invention thus firstly offers an alternative to the complexity of a continuous fabrication apparatus, in which in particular changing the decorative film 6 gives rise to considerable effort, by the replacement of an appropriate roll on the spool and, after that, the threading of a new strip of the decorative film 6 through the various press rollers has to be secured before it is possible to resume the production circuit again. Likewise, the present invention—as already mentioned—secondly offers an alternative to the double pressing operation which is needed in the case of fabrication with the use of discontinuous apparatuses.

The present invention is not restricted to the exemplary embodiments described but comprises all equivalent variants in the sense of the invention.

Variants and changes can primarily relate to the addition of intermediate layers or additional layers above, below or between the existing layers. These variants do not depart from the scope of the invention.

Furthermore, the invention is not restricted to the feature combination defined in claim 1 and the other independent claims, but can also be defined by any other desired combination of features of all the individual features disclosed. This means that, in principle, any individual feature of the claims can be left out or replaced by at least one feature disclosed at another point in the application. To this extent, claim 1 is to be understood merely as a first attempt at a formulation for an invention.

1. A compensating element, in the form of an impregnated backing, for laminated floorboards comprising an impregnated paper, wherein the impregnated paper is joined to an insulating layer.

2. The compensating element as claimed in claim 1, wherein the impregnated paper is joined to the insulating layer by means of and impregnant of the paper.

3. The compensating element as claimed in claim 1, wherein the insulating layer is formed of a sound-damping material layer and is applied to the impregnated paper by means of an adhesive coating.

4. The compensating element as claimed in claim 1, wherein the impregnated paper is joined to the insulating layer by means of the attractive action in the presence of electrostatic charging.

5. The compensating element as claimed in claim 3, wherein the sound-damping insulating layer is comprised of one or more materials of the group including cork, pressed wood chips with a low density, felt, or compositions formed by using synthetic fibers, such as woven fabrics, nonwoven fabrics or films, of form, of granulated rubber or paperboard.

6. The compensating element as claimed in claim 5, wherein the foam is formed of polyurethane.

7. The compensating element as claimed in claim 6, wherein the polyurethane foam consists of recycled polyurethane foam, composite polyurethane foam and binder.

8. The compensating element as claimed in claim 3, wherein the adhesive coating consists of a hot-melt adhesive, a contact adhesive or an emulsified adhesive based on a copolymer.

9. The compensating element as claimed in claim 1, wherein the impregnated paper consists of a kraft paper.

10. The compensating element as claimed in claim 8, wherein the adhesive coating is formed by at least two adhesive tracks running in parallel.

11. The compensating element has claimed in claim 3, wherein the thickness of the sound-damping insulating layer, is 2 to 4 mm.

12. The compensating element as claimed in claim 6, wherein the polyurethane foam layer has a density of 200 to 400 kg/m³.

13. The compensating element as claimed in claim 1, wherein the paper is formed as recycled paper based on superior chemical pulps or as soda kraft paper and with base paper weight of 70 to 140 g/m².

14. The compensating element as claimed in claim 1, wherein impregnation of the paper is formed from one or more of an aminoplastic resin comprising urea and/or melamine resins, the final weight of the paper following impregnation and drying being 170 to 320 g/m².

15. A laminated floorboard, in the form of a flooring laminate, comprising a supporting board which is coated on an upper side and is provided on an underside with a compensating element, in the form of an impregnated backing, wherein the compensating element, having an impregnated paper joined with an insulating layer in the form of a sound-damping layer joined by means of an adhesive coating, the compensating element is joined to the supporting board, the insulating layer forming the lowest layer of the composite.

16. The laminated floorboard as claimed in claim 15, wherein the compensating element is joined to the supporting board by means of the impregnated paper by pressing.

17. The laminated floorboard as claimed in claim 15, wherein the supporting board consists of an HDF, MDF, chipboard or recycled board.

18. The laminated floorboard as claimed in one claim 15, wherein a coating of an impregnated decorative paper and an overlay lying over the decorative paper is arranged on the upper side of the supporting board.

19. A process for production of a compensating element, in particular an impregnated backing, wherein impregnated paper brought to a predefined dimensioned in paper blanks is stacked to form a paper stack, in each case a paper blank is lifted off the stack upper side and its deposited on a web of insulating material matched to the dimensions of the paper blank, the side of the web of insulating material that faces the paper to be deposited being provided with an adhesive layer before the deposition of the paper blank.

20. The process as claimed in claim 19, wherein the web of insulating material is unwound from a roll of insulating material and is pulled over a supporting surface until the section of the web of insulating material resting on the supporting surface has at least the length of the paper blank be deposited, the web of insulating material being held in the unwound position during the deposition of the paper blank.

21. The process as claimed in claim 20, wherein the paper blanks are fed to the web of insulating material from one or two paper stacks said paper stacks being arranged on one or both sides of the supporting surface in relation to a haul-off direction of the web of insulating material.

22. The process as claimed in claim 20 wherein, following the deposition of the paper blank, the fixed web of insulating material is cut to length in accordance with the length of the paper blank, forming a blank of the compensating element.

23. The process as claimed in claim 22, wherein, after the web of insulating material has been cut to length, the blank of the compensating element, is in each case lifted off the supporting surface and stacked to form a stack, the paper in each case forming the upper side of the stack.

24. The process as claimed in claim 23, wherein the blank of the compensating element, is stacked on a stack preferably placed on a pallet, said stack being arranged beside or behind the supporting surface in relation to a haul-off direction (X) of the web of insulating material.

25. The process as claimed in claim 20, wherein the application of the adhesive layer is carried out as the web of insulating material is unwound from the roll of insulating material.

26. The process for production of a compensating element, in particular an impregnated backing, wherein the impregnated backing paper and an insulating underlay in the form of a sound-damping material layer, are in each case pulled off rolls in the form of webs and are subsequently pressed against each other in an arrangement lying one above the other, before the pressing the adhesive coating being applied to the insulating underlay, in particular the sound-damping material layer, on its side facing the backing paper web.

27. The process as claimed in claim 26, wherein the bonded backing paper web and the web of insulating material formed from the insulating underlay are pulled off until the desired length of the impregnated backing is reached, the haul-off speed is then stopped, the impregnated backing is cut to length and then transported onward to be stacked.

28. An apparatus for production of a compensating element for laminated floorboards, which comprises a supporting apparatus which has a supporting surface for a web of insulating material and on which at one end there is arranged an unwinding device for unwinding the web of insulating material from a roll of insulating material, by a crosscutter arranged after the unwinding device in the haul-off direction (X), a gripping device which can be displaced in and counter to the haul-off direction (X) along the supporting apparatus for the web of insulating material, and at least one lifting, depositing and transport apparatus arranged above the supporting surface for the transport of an impregnated paper blank and/or a compensating element blank transversely with respect to the haul-off direction (X).

29. The apparatus as claimed in claim 28, wherein an adhesive applicator for applying an adhesive coating to the web of insulating material is arranged above the supporting surface immediately after the crosscutter in the haul-off direction (X).

30. The apparatus as claimed in claim 28, wherein the lifting, depositing and transport apparatuses is guided such that it can be displaced between two portal carriers arranged transversely, in particular at right angles, to the haul-off direction (X) and parallel to each other, on horizontal carrier sections and can be moved independently of each other.

31. The apparatus as claimed in claim 28, wherein there are two transport apparatuses, of which at least one transport apparatus (31, 31a), preferably both transport apparatuses, are assigned to the transport of the paper blanks and, if appropriate, the second transport apparatus is assigned to the transport of the impregnated backing blanks.

32. The apparatus as claimed in claim 31, wherein the transport apparatus for the paper blanks comprises suckers pressure strips which are fixed to a common transport frame and can be lifted and lowered, their contact surfaces for the paper blanks lying in a common plane.

33. The apparatus as claimed in claim 31, wherein the transport apparatus for the impregnated backing blanks comprises a plurality of vacuum suckers which can be lowered and lifted and whose contact surfaces for the impregnated backing blanks lie in a common contact plane.

34. The apparatus as claimed in claim 32, wherein the suckers are arranged in such a way and the suckers and the pressure strips are distributed in such a way that smooth lifting and lowering of the paper blanks is carried out.

35. The apparatus as claimed in claim 28, wherein the unwinding device has a drive motor to drive the roll of insulating material, the unwinding speed of the drive motor and the displacement speed of the gripping device being coordinated with each other.

36. The apparatus has claimed in claim 28, wherein the gripping device that can be displaced along the supporting apparatus in and counter to the haul-off direction (X) is guided on a guide strip.

37. The apparatus as claimed in claim 36, wherein the guide strip for the gripping device is adjoined by a guide rod which goes beyond the supporting surface in the haul-off direction (X).

38. The apparatus as claimed in claim 28, wherein a lifting table to accommodate a stack of impregnated backing components is arranged after the supporting surface in the haul-off direction (X).

39. The apparatus as claimed in claim 28, wherein, in order to convey the impregnated paper blanks and/or the impregnated backing blanks in and out, standby spaces and/or at least one storage space are provided, from or to which the stacks of impregnated paper blanks and the impregnated backing blanks are transported with the aid of transverse conveyors or longitudinal conveyors.

40. A process for production of at laminated floorboard, wherein in order to obtain a compensating element, in the form of an impregnated backing a compensating film, in the form of impregnated paper is fixed to the insulating underlay and, after that, the composite formed in this way is laid on aids, then a/the supporting board as a core consisting of wooden material, a decorative layer preferably formed by a/the decorative paper, in particular impregnated with melamine resin, and the overlay are laid successively on the composite and, finally, the whole formed by these aforementioned layers is gripped, placed in a pressing apparatus and pressed.

41. The process as claimed in claim 40, wherein the impregnated backing, is gripped, held and moved by using gripping means based on the action of vacuum, such as suckers.

42. The process as claimed in claim 40, wherein the pressing is carried out under a pressing pressure of 20 to 40 bar at pressing temperatures of 160 to 200° C. and pressing times of 10 to 30 s.
